(19) United States
(12) Patent Application Publication
(10) Pub. No.: US 2004/0141672 A1
(43) Pub. Date: Jul. 22, 2004

(54) Resin-made ball retainer for a rolling bearing

(75) Inventors: Kenichiro Naito, Kuwana-shi (JP); Hiroaki Suzuki, Kuwana-shi (JP); Kengo Hiramatsu, Kuwana-shi (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 10/706,271

(22) Filed: Nov. 13, 2003

(30) Foreign Application Priority Data
Nov. 15, 2002 (JP) 2002-332212

(51) Int. Cl. F16C 33/41

(52) U.S. Cl. 384/531

(57) ABSTRACT

To provide a resin-made ball retainer for a rolling bearing wherein improvement is made to the lubrication in a region between an inner surface of each of pockets and a corresponding ball to thereby suppress generation of vibrations and noises due to friction in that region, the resin-made ball retainer includes a plurality of pockets (3) defined in a plurality of portions of a ring-shaped or arcuate retainer body (1) so as to open at the inner and outer peripheral surfaces thereof for rollingly retaining corresponding balls (2) therein. Radial sides of an inner surface of each of the pockets (3) that are opposite to each other in a radial direction of the ball retainer are defined as spherical ball bearing surfaces (5) to which each ball contacts. Also, intermediate portions of the inner surface of each pocket with respect to the radial direction are defined as circumferential non-contact surface areas (6) where the corresponding ball (2) does not contact. All edges of the ball bearing surfaces on the inner surface of each pocket (3), which may contact the ball (2), are defined as chamfered edges.

### BACKGROUND OF THE INVENTION

1. Field of the Invention

The present invention generally relates to a rolling bearing and, more particularly, to a ball retainer for the rolling bearing for retaining a plurality of rolling elements such as balls. The resin-made ball retainer of the present invention is suitably employed in an ultra thin-walled ball bearing, in which the thickness represented by the difference between outer and inner diameters is extremely small, and a standard deep groove ball bearing.

2. Description of the Prior Art

A conventional ball retainer has a plurality of pockets each having a single curved surface of a radius of curvature slightly greater than the outer diameter of any one of balls rollingly received within those pockets. A gap formed between each pocket surface and the corresponding ball is chosen to be small in order to minimize generation of retainer sounds, which occur when the rolling balls collide against the associated pockets, and also to suppress the amount of motion of the ball retainer.

Also, the following ball retainers have hitherto been suggested. Specifically, the Japanese Laid-open Patent Publication No. 10-82424 discloses a ball retainer in which at least a portion of a peripheral lip region of each pocket is chamfered to represent an arcuately curved surface when viewed in section. The radius of curvature of the chamfered portion is set within the range of 1 to 20% of the outer diameter of each ball.

The Japanese Laid-open Patent Publication No. 10-19046 discloses a ball retainer in which an edge of a peripheral lip region of each pocket, which is in opposition to the direction of rotating advance of balls is chamfered.

The Japanese Laid-open Patent Publication No. 11-166540 discloses a ball retainer in which recesses (including chamfers) are provided in a peripheral lip region of each pocket.

The Japanese Laid-open Patent Publication No. 2002-98150 discloses a ball retainer in which recesses, which do not contact balls, are provided in a surface in a direction conforming to the axial direction of pockets.

As discussed above, in the prior art ball retainers, the gap between the pocket surface and each ball is chosen to be small in order to minimize generation of retainer sounds, which occur when the rolling balls collide against the associated pockets, and also to suppress the amount of motion of the ball retainer. It has, however, been found that if the gap is so small, flow of a lubricant between each of the pockets and the corresponding ball tends to be hampered. Because of this, lubrication of a slide contact area between the ball retainer and the balls tends to be degraded, resulting in an easy generation of vibrations and noises by the effect of friction due to this slide contact.

Also, it may often occur that during the operation of the bearing assembly the lubricant sticking to the rolling elements then rolling is scraped off from the rolling elements in contact with peripheral edges of the pockets, and accordingly, lubrication between the rolling elements and the inner surfaces of the pockets tends to be lowered, resulting in an easy generation of vibrations and noises due to friction therebetween.

Although the prior art ball retainers discussed above are so designed as to facilitate a smooth introduction of a lubricant into the inner surface of each of the pockets by the provision of chamfers in the peripheral lip region of each pocket or by the provision of recesses in the peripheral lip region of each pocket, the need has arisen to provide a ball retainer capable of improving the flow of the lubricant.

### SUMMARY OF THE INVENTION

In view of the foregoing, the present invention is intended to provide a resin-made ball retainer for a rolling bearing wherein improvement is made to the lubrication in a region between the inner surface of each of pockets and a corresponding ball to thereby suppress generation of vibrations and noises due to friction in that region.

In order to accomplish the foregoing object, the present invention provides a resin-made ball retainer for a rolling bearing, which includes a ring-shaped or arcuate retainer body having inner and outer peripheral surfaces opposite to each other, and a plurality of pockets defined in the retainer body so as to open at the inner and outer peripheral surfaces thereof and spaced from each other in a direction circumferentially thereof for rollingly retaining corresponding balls as rolling elements therein. Radial sides of an inner surface of each of the pockets that are opposite to each other in a radial direction of the ball retainer are defined as spherical ball bearing surfaces to which each ball contacts. Also, intermediate portions of the inner surface of each pocket with respect to the radial direction are defined as circumferential non-contact surface areas where the corresponding ball does not contact. Substantially all edges, that is, all or almost all edges of the ball bearing surfaces on both sides of each pocket, which may contact the ball, are defined as chamfered edges.

According to the present invention, contact do not occur between the circumferential non-contact areas and balls and the lubricant can be retained in those gaps defined between them and, accordingly, the lubricant so retained can be supplied to the slide contact areas each between the ball bearing surfaces of the respective pocket and the corresponding ball during operation of the bearing. Because of this, lubrication at the slide contact areas can be maintained in a favorable condition. Also, since all of the edges of the ball bearing surfaces on both sides of each of the pockets, which may contact the ball, are chamfered, the lubricant, for example, a grease sticking to the surface of the ball is not easily scraped off by the edges of the ball bearing surfaces of each pocket and, therefore, the lubricant can easily be introduced into portions of the respective pocket where lubrication is required. As a result, the slide contact area between each pocket and the corresponding ball can be kept in a satisfactorily lubricated condition, and vibrations and noises which would be generated from the slide contact areas can advantageously be suppressed.

In the present invention, a portion of the inner surface of each pocket, which lies in a direction intersecting the direction of rotation of the ball retainer, may be formed with intersecting oil reservoir grooves each being in the form of a generally elongated recess of a curved surface and extending in a direction radially of the ball retainer.

This structural features permits the lubricant retained in the intersecting oil reservoir groove to be also supplied to the slide contact area between each ball and the ball bearing surfaces of the respective pocket. Accordingly, the lubrication at the slide contact areas can be maintained in a more favorable condition.

Also in the present invention, each of the pockets may have an opening defined so as to open at one end of the ball retainer with respect to an axial direction of the ball retainer and the bottom of the inner surface of each pocket opposite to such opening may be correspondingly formed with a bottom oil reservoir groove of a generally concaved shape. The bottom oil reservoir groove may extend in, for example a direction radially of the ball retainer.

According to this structural features, the lubricant retained in the bottom oil reservoir groove can also be supplied to the slide contact area between each ball and the ball bearing surfaces of the corresponding pocket during the operation of the bearing and, therefore, the lubrication at that slide contact area can advantageously be maintained in a further favorable condition. In view of this, vibrations and noises which would be generated from the slide contact area between each ball and the corresponding pocket can further be suppressed.

Again, in the present invention, a radial thickness of a general or base portion of the retainer body may be made small relative to a radial thickness of a portion of the retainer body adjacent each pocket.

According to this structural feature, where this feature is applied to a thin-walled bearing of a large diameter, it is possible to suppress generation of rubbing sounds as a result of contact between the ball retainer and the inner peripheral surface of an outer race and/or the outer peripheral surface of an inner race particularly in the ball retainer of a type in which a plurality of generally arcuate segments are connected in an annular configuration. Also, in view of the fact that the lubricant such as a grease can be retained in an annular space delimited between the ball retainer and one or both of the inner peripheral surface of the outer race and the outer peripheral surface of the inner race, the lubricant can easily be supplied into each pocket. Because of this, the lubrication at the slide contact area between the outer peripheral surface of each ball and the pocket surface of the ball retainer can advantageously be kept in a favorable condition, and the vibrations and noises which would be generated from this slide contact area can also be suppressed advantageously.

Furthermore, in the present invention, respective portions of one axial end of the retainer body where the corresponding pockets are defined may be each provided with a pair of projections for embracing the corresponding ball, in which case an inner surface of each of those projections defines a part of the inner surface of the respective pocket. A so-called crown-type ball retainer can be assembled. The projections may be represented by respective claws so curved as to follow the spherical surface of each ball.

The provision of the projections is effective to increase a length as measured in a direction circumferentially of the inner surface of each pocket without the increase in an axial thickness of the ball retainer and, therefore, the respective ball can be advantageously snugly retained within the associated pocket.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary perspective view, showing a portion of a resin-made ball retainer for a rolling bearing according to a preferred embodiment of the present invention;

FIG. 2 is a fragmentary top plan view of a portion of the resin-made ball retainer, showing only one of pockets defined therein;

FIG. 3 is a fragmentary top plan view, on an enlarged scale, of a portion of the resin-made ball retainer shown in FIG. 2;

FIG. 4 is a horizontal sectional view of a portion of the resin-made ball retainer;

FIG. 5 is an elevational view of a portion of the resin-made ball retainer as viewed in a direction conforming to the radial direction thereof;

FIG. 6A is an elevational view of the resin-made ball retainer, formed as a segment type, as viewed in a direction conforming to the radial direction of the ball retainer;

FIG. 6B is a rear view of the resin-made ball retainer shown in FIG. 6A;

FIG. 6C is a plan view of the resin-made ball retainer of FIG. 6A, shown as developed straight;

FIG. 7A is an enlarged view of a portion of the resin-made ball retainer of FIG. 6A, which is encompassed by the phantom circle VII in FIG. 6A;

FIG. 7B is a plan view of that portion of the resin-made ball retainer as viewed along the line b-b in FIG. 7A;

FIG. 7C is a right side view of that portion of the resin-made ball retainer shown in FIG. 7A;

FIG. 7D is a top plan view of that portion of the resin-made ball retainer shown in FIG. 7A; and

FIG. 8 is a sectional view of a bearing in which the resin-made ball retainer is employed.

### DETAILED DESCRIPTION OF THE EMBODIMENTS

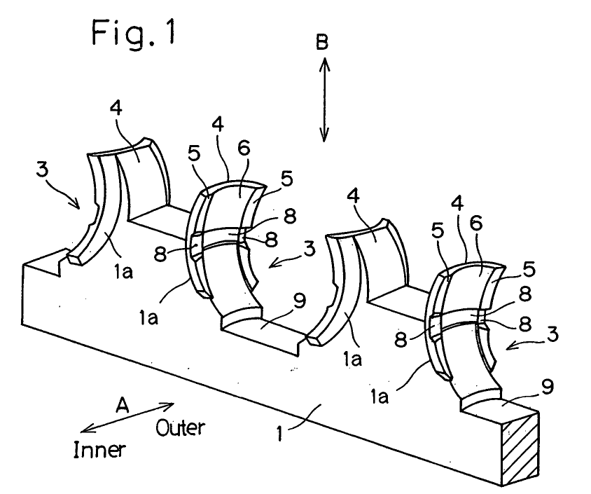

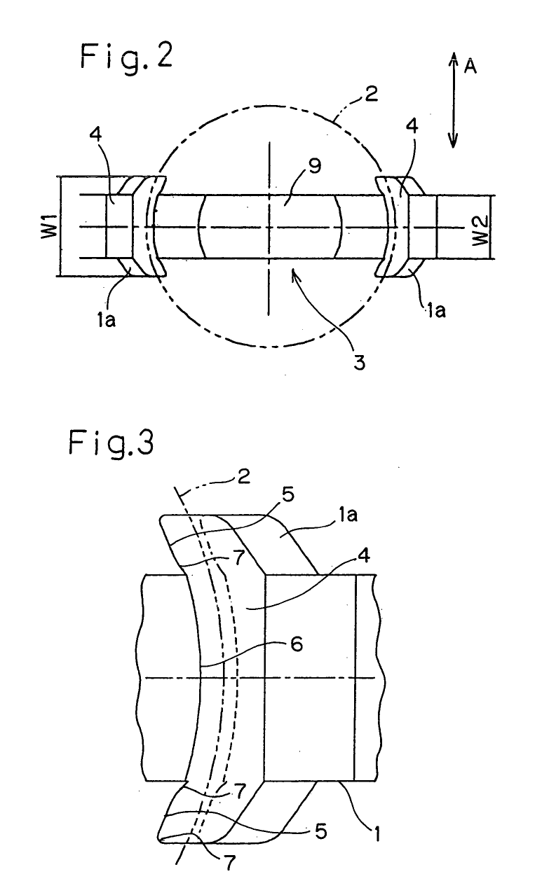

The first preferred embodiment of the present invention will now be described in detail with particular reference to FIGS. 1 to 5. As shown in FIG. 1 in a fragmentary representation, a ball retainer for a ball bearing, which is made of a synthetic resin, includes a generally ring-shaped or arcuate retainer body 1 having a plurality of pockets 3 defined therein for receiving respective rolling elements, that is, balls 2 (shown in FIG. 2) and spaced an equal distance from each other in a direction circumferentially thereof. As will become clear from the subsequent description, each of the pockets 3 is so defined in the retainer body 1 as to open at inner and outer peripheral surfaces of the retainer body 1. Respective portions of one of opposite end faces of the retainer body 1 in an axial direction shown by the arrow B, where the corresponding pockets are defined, are each formed with a pair of projections 4 and 4 that embrace the associated ball 2. Inner surfaces of each of the paired projections 4 and 4 that confront with each other define respective parts of an inner surface of the corresponding pocket 3. Those projections 4 and 4 are each in the form of a claw so curved as to follow the curvature of the ball 2.

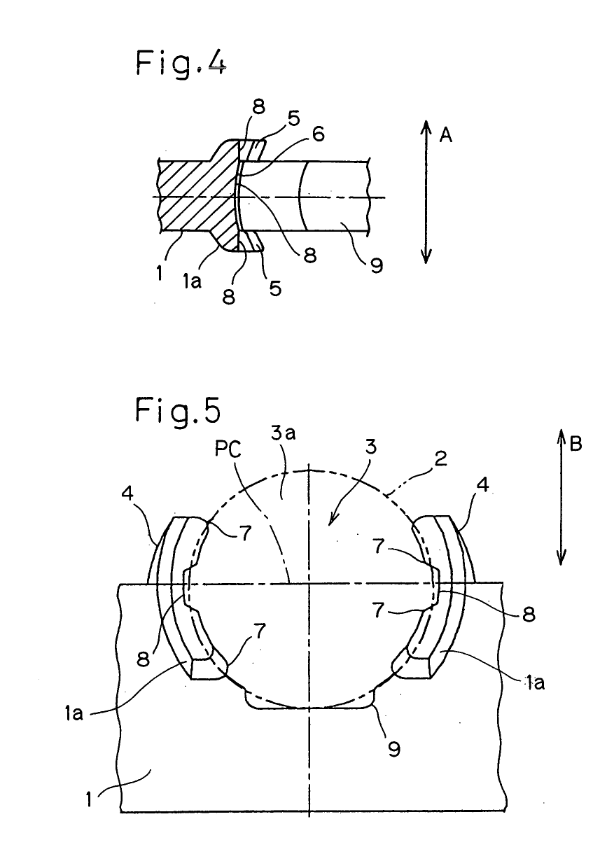

Opposite edge portions of the inner surface of the pocket 3 with respect to the radial direction of the ball retainer shown by the arrow A define substantially spherical ball bearing surfaces 5 and 5 which contact the corresponding ball 2. The terms “Inner” and “Outer” shown in FIG. 1 in combination with the arrow A denote directions radially inwardly and outwardly of the ball retainer, respectively. The ball bearing surfaces 5 and 5 are of a configuration concentric with a rolling contact surface of the ball 2 and have a radius of curvature slightly greater than that of the rolling contact surface of the ball 2. Respective portions of the inner surface of the pocket 3, each intermediate between the ball bearing surfaces 5 and 5, are inwardly depressed to define circumferential non-contact surface areas 6 which do not contact the ball 2, but allows only the ball bearing surfaces 5 and 5 to rollingly support the ball 2. The non-contact surface area 6 in each of the pockets 3 is represented by a bottom of a shallow groove extending in a direction circumferentially of the pocket 3 with respect to the ball bearing surfaces 5 and 5. More specifically, the non-contact surface areas 6 of the pocket 3 are in the form of a spherically concaved surface or a cylindrically concaved surface concentric with the rolling contact surface of the ball 2 and having a radius of curvature slightly greater than that of the rolling contact surface of the ball 2. All edges of the ball bearing surfaces 5 and 5 on both sides of the pocket 3, which may contact the ball 2, are defined as chamfered edges 7 as shown in FIGS. 3 and 5.

Portions of the inner surface of the respective pocket 3 which lie in a direction intersecting the direction of rotation of the ball retainer, that is, in the circumferential direction of the ball retainer are defined as intersecting oil reservoir grooves 8 each being in the form of a generally elongated recess of a curved surface and extending in a direction radially of the retainer body 1 shown by the arrow A. Each of the intersecting oil reservoir grooves 8 is so defined in each of the pockets 3 as to straddle, for example, from one side to the other of the axial position of the ball retainer which generally coincides with the pitch circle PC (FIG. 5) in which the balls 2 are arranged in a circumferential row. FIG. 4 illustrates a fragmentary sectional view of a portion of the ball retainer cut along the position of the ball retainer where one of the intersecting oil reservoir groove 8 is defined. Each of the intersecting oil reservoir groove 8 is in the form of a curved concave surface, or a cylindrical or square-sectioned concave surface concentric with the rolling contact surface of the ball 2 rollingly retained in the pocket 3 and having a radius of curvature slightly greater than the curvature of the corresponding ball bearing surface 5,. So far shown, each of the intersecting oil reservoir grooves 8 has its bottom surface representing a cylindrical surface and represents such a trapezoidal shape that, when the ball retainer is viewed from the radial direction, the respective intersecting oil reservoir groove 8 opens, being flared from its bottom surface as clearly shown in FIG. 5.

The pocket 3 has, on one side with respect to the axial direction of the ball retainer as shown by the arrow B, an axial opening 3a delimited between the paired projections 4 and 4 as hereinbefore described. A bottom of the pocket 3 opposite to the axial opening 3a is formed with a bottom oil reservoir groove 9 of a generally concaved shape. This groove 9 extends in the radial direction of the ball retainer as shown by the arrow A. While the bottom oil reservoir groove 9 has a depth which allows the ball 2 to contact the bottom of the oil reservoir groove 9 when the ball 2 assumes the lowermost position within the pocket 3, the bottom oil reservoir groove 9 may be formed so deep as to avoid a contact between the ball 2 and the bottom of the oil reservoir groove 9. Provided that the bottom oil reservoir groove 9 satisfies this condition as to the depth thereof, the bottom oil reservoir groove 9 may have a cylindrical sectional shape, a sectional shape similar to the square-sectioned tube or a spherically concaved shape that is concentric with the rolling contact surface of the ball 2 and has a radius of curvature slightly greater than that of the non-contact surface area 6. In the illustrated embodiment, the bottom oil reservoir groove 9 has a sectional shape similar to that of the square-sectioned tube.

As shown in a top plan view in FIG. 2, the thickness of the retainer body 1 is such that a radial thickness W2 of a general portion of the retainer body 1 is smaller than a radial thickness W1 of a pocket-adjacent portion of the retainer body 1. In other words, that portion of the retainer body 1 adjacent each pocket 3 is formed as a thick walled portion 1a of a thickness greater than the radial thickness W2 of the general portion of the retainer body 1. Owning to this thick walled portion 1a, a required radial width can be secured in the inner surface of the ball retainer. The general portion of the retainer body 1 is a portion of the retainer body 1 excluding the pocket-adjacent portion of the retainer body. This general portion of the retainer body 1 may have a uniform thickness equal over the entire circumference of the retainer body 1. It is to be noted that the thick walled portion 1a is not provided in the vicinity of the bottom of each pocket 3 and is formed at two circumferentially confronting locations having been so separated. The thick walled portion 1a extends from a free end of each projection 4 along an open edge of the pocket 3 towards a pocket bottom side beyond a root of the respective projection 4.

With the resin-made retainer of the structure discussed above, the opposite sides of the inner surface of each of the pockets 3 in the radial direction shown by the arrow A are defined as the spherical ball bearing surfaces 5 to which the respective ball 2 contacts and the intermediate portions of the inner surface of the pocket 3 in the radial direction are defined as the circumferentially extending non-contact surface areas 6 to which the respective ball 2 does not contact. Accordingly, a lubricant can be retained in a gap delimited between each of the circumferentially extending non-contact surface areas 6 and the associated ball 2 and, therefore, during the operation of the bearing, the lubricant so retained in that gap can be supplied to areas of contact between the respective ball 2 and the ball bearing surfaces 5. Thus, lubrication at those areas of contact can advantageously be maintained in a favorable condition.

Also, since substantially all of the edges of the ball bearing surfaces 5 which may contact the ball 2 are formed as the chamfered edges 7, the lubricant such as a grease adhering to the surface of the ball 2 will hardly be scraped off by the edges of the ball bearing surfaces 5 of each pocket 3 and, therefore, the lubricant can easily be introduced into portions of the respective pocket 3 where lubrication is required.

In addition, since that portion of the inner surface of each pocket 3 which lies in a direction intersecting the direction of rotation of the bail retainer is formed with the intersecting oil reservoir grooves 8 each being in the form of a generally elongated recess of a curved surface and extending in a direction radially of the ball retainer shown by the arrow A, the lubricant so retained in the intersecting oil reservoir grooves can, during the operation of the bearing, be supplied to areas of sliding contact between the ball 2 and the ball bearing surfaces 5 and, accordingly, lubrication at those areas of contact can advantageously be maintained in a favorable condition.

Also, since the bottom oil reservoir 9 of a generally concaved shape extending in the radial direction of the ball retainer as shown by the arrow A is defined in the bottom of the inner surface of each pocket 3, the lubricant retained in the bottom oil reservoir groove 9 can, during the operation of the ball bearing, be also supplied to areas of sliding contact between the ball 2 and the ball bearing surfaces 5. Accordingly, lubrication at those areas of sliding contact can advantageously be maintained in a favorable condition.

As hereinabove described, since the inner surface of each pocket 3 is, in addition to the ball bearing surfaces 5, provided with the various concaved surfaces (the non-contact surface areas 6, the intersecting oil reservoir grooves 8 and the bottom oil reservoir groove 9), and also since the edges of the ball bearing surfaces 5 of each pocket 3 are formed as the chamfered edges 7, the lubricant can easily and effectively introduced inside the respective pocket 3 and lubrication at areas of sliding contact between the ball 2 and the pocket 3 can be maintained advantageously in a favorable condition, wherefore generation of undesirable vibrations and noises from those areas of contact can be suppressed.

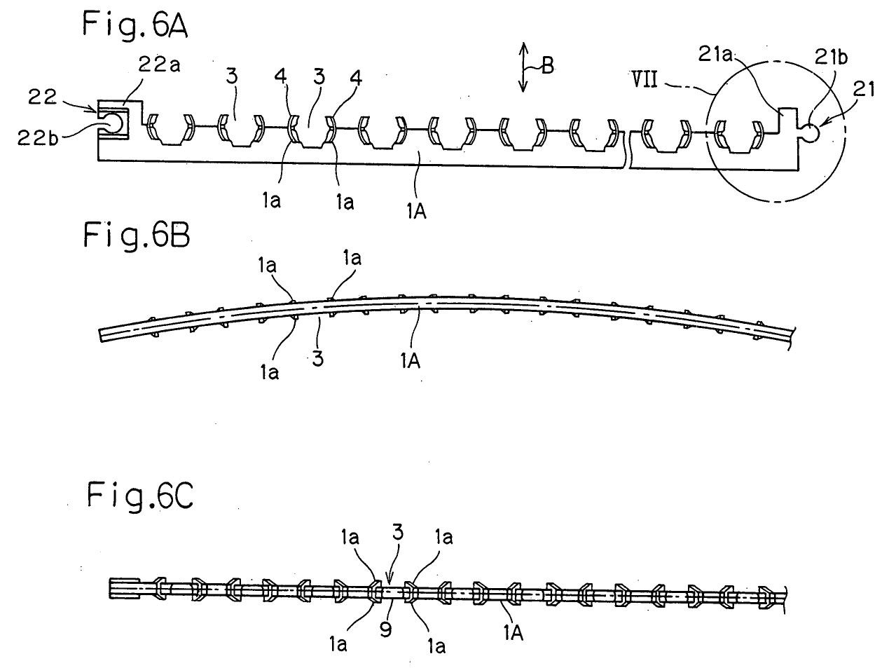

Yet, since the thickness of the retainer body 1 is such that the radial thickness W2 of the general portion of the retainer body 1 is chosen to be smaller than the radial thickness W1 of the pocket-adjacent portion of the retainer body 1, it is possible to effectively suppress rubbing sounds which would be generated as a result of contact between the retainer and an inner peripheral surface of an outer race and/or an outer peripheral surface of an inner race, particularly in the case of application to a bearing having a large diameter and a small wall thickness. Specifically, in the ball retainer of a type in which a plurality of generally arcuate segments 1A are connected in an annular configuration as shown in FIG. 6, the rubbing sounds which appear to occur can be suppressed effectively. Since as discussed above the general portion of the retainer body 1 has a relatively small wall thickness W2, the lubricant such as a grease can be retained in a gap between the retainer and the inner peripheral surface of the outer race and/or the outer peripheral surface of the inner race for the smooth introduction of such lubricant into the pocket 3. Because of this, not only can lubrication at those areas of sliding contact be maintained advantageously in a favorable condition, but any undesirable generation of vibrations and noises from those areas of contact can also be further suppressed efficiently.

Furthermore, since each of the portions of one end face of the retainer body 1 in an axial direction shown by the arrow B, where the pockets 3 are formed, includes the pair of the projections 4 and 4 for embracing the corresponding ball 2 with the inner surfaces of each of those projections 4 and 4 defining respective parts of the inner surface of the associated pocket 3, the inner surface of each pocket 3 can have an increased circumferential length without increasing the axial thickness of the retainer body 1 and, therefore, the corresponding ball 2 can be stably retained within the pocket 3.

It is to be noted that although in the foregoing embodiment the retainer body 1 has been described in the form of a non-split ring, the ball retainer according to the present invention may be made up of, for example, a plurality of generally arcuate segments 1A that are connected in a circular configuration as shown in FIGS. 6A to 6C. Each of those segments 1A corresponds to one of generally arcuate, circumferentially arranged pieces obtained by splitting the ring-shaped retainer of the structure shown in and described in connection with the foregoing embodiment and has its opposite ends provided respectively with mutually engageable coupling elements 21 and 22. Those coupling elements 21 and 22 define a segment joint at which the circumferentially neighboring segments 1A are connected with each other. By connecting the respective coupling elements 21 and 22 of the neighboring segments 1A, the ring-shaped retainer can be obtained.

Of the coupling elements 21 and 22, the coupling element 21 at one end of the segment 1A includes a coupling body 21a and a coupling projection 21b protruding outwardly from the coupling body 21a in the circumferential direction, whereas the coupling element 22 at the opposite end of the segment 1A includes a coupling body 22a and a coupling recess 22b formed in an end face of the coupling body 22a in a shape complemental to the shape of the coupling projection 21b. The coupling projection 21b is continued from a neck portion protruding outwardly from the coupling body 21a and has a head that is larger than the neck portion, which head when viewed in a direction radially of the ball retainer represents, for example, a generally round shape. On the other hand, the coupling recess 22b represents such a shape that the entire coupling projection 21b can be radially removably engaged in the coupling recess 22b.

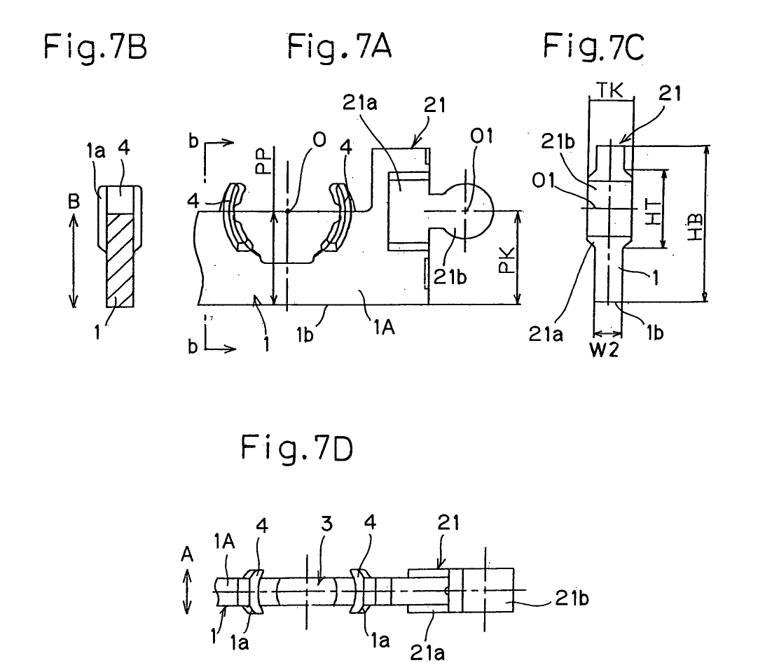

FIGS. 7A to 7D illustrate enlarged views of a portion of the segment 1A that is encompassed by the phantom circle VII in FIG. 6A. The coupling elements 21 and 22 have the following structural features (1) to (3):

(1) The respective centers O1 of the coupling elements 21 and 22 (specifically, the center of the coupling projection 21b in the case of the convexed-surface coupling element 21 and the center of the coupling recess 22b (FIG. 6A) in the case of the concaved-surface coupling element 22) are axially aligned with the center O of each pocket 3, as shown in FIG. 7A. In other words, the distance PK from the respective centers O1 of the coupling elements 21 and 22 to the axial end face 1b of the retainer body 1 opposite to the surface thereof from which the projections 4 and 4 protrude is equal to the distance PP from the center O of each pocket 3 to the axial end face 1b of the retainer body 1.

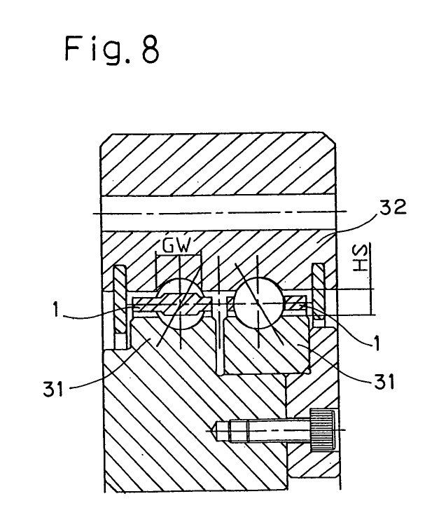

(2) The radial thickness TK of respective portions of the coupling elements 21 and 22 which have the largest thickness is chosen to be greater than the radial thickness W2 of the general portion of the retainer body 1, as shown in FIG. 7C. (It is to be noted that since the ball retainer of this type is incorporated by inserting into an annular gap between the outer and inner races, the uppermost limit of the thickness TK is limited to a value not greater than the height HS of an annular gap delimited between the inner race 31 and the outer race 32 of the bearing, as shown in FIG. 8. Also, the axial width HT (FIG. 7C) of respective portions of the coupling elements 21 and 22 that have the radial thickness TK has to be chosen within the range possible to avoid an undesirable interference with the width GW (FIG. 8) of a raceway groove in each of the inner and outer races 31 and 32 and is, therefore, chosen to be a maximum value within such range.

(3) The respective axial width HB (FIG. 7C) of the coupling elements 21 and 22 is chosen to be larger than the width of a portion of the ball retainer which has the maximum axial width (i.e., a portion of the retainer body 1 from which each projection 4 protrudes). This axial width HB is chosen to be, for example, a maximum value at which after the ball retainer has been inserted into the bearing, no interference with structural elements around the ball retainer will occur.

The action which takes place when the foregoing structural features (1) to (3) are employed will now be described.

In the case where the structural feature (1) is employed, loading of the moment on the segment coupling elements 21 and 22, which would result from a delay or advance of balls, can advantageously be prevented to thereby suppress drift and/or deformation of the segment 1A in the axial direction shown by the arrow B due to the loading of the moment and, therefore, the bearing can operate at high speed with minimized noise.

In the case where the structural features (2) and (3) are employed, the rigidity of the segment coupling elements 21 and 22 can be increased, and any undesirable deformation of the coupling elements 21 and 22, which would otherwise result from a delay or advance of balls during the operation of a bearing, can also be suppressed to thereby avoid generation of noises and increase of the torque. It is to be noted that in the case of the segment type retainer, while deformation of coupling elements resulting from a delay or advance of balls cause the ball retainer to rotate with its side shape deformed from the complete round shape to the polygonal shape, generation of obnoxious sounds and increase of the torque occur with the balls constrained within the respective pockets in the ball retainer. However, the employment of the structural features (2) and (3) discussed above is effective to alleviate such problems.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A resin-made ball retainer for a rolling bearing, which comprises:
a ring-shaped or arcuate retainer body having inner and outer peripheral surfaces opposite to each other; and
a plurality of pockets defined in the retainer body so as to open at the inner and outer peripheral surfaces of the retainer body and spaced from each other in a direction circumferentially thereof for rollingly retaining corresponding balls therein;
wherein radial sides of an inner surface of each of the pockets that are opposite to each other in a radial direction of the ball retainer are defined as spherical ball bearing surfaces to which each ball contacts;
wherein intermediate portions of the inner surface of each pocket with respect to the radial direction are defined as circumferential non-contact surface areas where the corresponding ball does not contact; and
wherein substantially all edges of the ball bearing surfaces of the inner surface of each pocket, which may contact the ball, are defined as chamfered edges.

2. The resin-made ball retainer for the rolling bearing as claimed in claim 1, wherein portions of the inner surface of each pocket, which lie in a direction intersecting the direction of rotation of the ball retainer, are formed with intersecting oil reservoir grooves each being in the form of a generally elongated recess of a curved surface and extending in a direction radially of the ball retainer.

3. The resin-made ball retainer for the rolling bearing as claimed in claim 1, wherein each of the pockets has an opening defined so as to open at one end of the ball retainer with respect to an axial direction thereof and wherein a bottom of the inner surface of each pocket opposite to such opening is formed with a bottom oil reservoir groove of a generally concaved shape.

4. The resin-made ball retainer for the rolling bearing as claimed in claim 1, wherein a radial thickness of a general portion of the retainer body is made small relative to a radial thickness of a portion of the retainer body adjacent each pocket.

5. The resin-made ball retainer for the rolling bearing as claimed in claim 1, wherein respective portions of one axial end of the retainer body where the corresponding pockets are defined are each provided with a pair of projections for embracing the corresponding ball and wherein an inner surface of each of those projections defines a part of the inner surface of the respective pocket.
